(19) United States
(12) Patent Application Publication
(10) Pub. No.: US 2024/0295801 A1
(43) Pub. Date: Sep. 5, 2024

(54) PROJECTOR AND CONTROL APPARATUS

(71) Applicant: SEIKO EPSON CORPORATION, Tokyo (JP)

(72) Inventors: Shinichi WAKABAYASHI, Suwa-shi (JP); Tatsuya TAKAHASHI, Azumino-shi (JP)

(21) Appl. No.: 18/593,005

(22) Filed: Mar. 1, 2024

(30) Foreign Application Priority Data
Mar. 3, 2023 (JP) 2023-033096

(51) Int. Cl. G03B 21/14; G02B 26/10; G02B 27/64

(52) U.S. Cl. CPC G03B 21/142; G02B 26/101; G02B 27/646

(57) ABSTRACT

A projector includes an optical path shifter that shifts the optical path of image light with respect to a reference position where the image light is projected, a vibration detection sensor that detects vibration that affects the position where the image light is projected, and a vibration suppressor that is disposed at either the side of the optical path shifter on which the image light is incident or via which the image light exits and includes an optical member through which the image light passes, and the vibration suppressor swings the optical member based on the result of detection performed by the vibration detection sensor to change the optical path of the image light having entered the optical member in a direction in which the reverse phase of the phase of the vibration is produced.

The present application is based on, and claims priority from JP Application Serial Number 2023-033096, filed Mar. 3, 2023, the disclosure of which is hereby incorporated by reference herein in its entirety.

### BACKGROUND

### 1. Technical Field

The present disclosure relates to a projector and a control apparatus.

### 2. Related Art

There is a known projector including an optical path deflector that changes the direction in which a projection system projects image light, a vibration detector that detects vibration, and an optical path deflection controller that controls the amount by which the optical path deflector changes the projection direction based on the vibration detected by the vibration detector (see JP-A-2017-191274, for example).

In the projector described in JP-A-2017-191274, the optical path deflector is an element that deflects the traveling direction of the image light to be projected onto a projection receiving surface, and the amount of change in the projection direction of the image light deflected by the optical path deflector is changed by driving a horizontal driver and a vertical driver.

When the detected vibration is greater than or equal to a first threshold, the optical path deflection controller controls the drivers in such a way that the image light projected by the projector moves to a position where the vibration acting on the projector is canceled out. Image blur at the projection receiving surface is thus suppressed.

When the detected vibration is smaller than the first threshold, the optical path deflection controller controls the drivers in such a way that the projector projects the image light at high resolution. For example, the optical path deflection controller effectively increase the number of vertical and horizontal pixels of the image to increase the resolution of the projected image by controlling the operation of the horizontal and vertical drivers in such a way that the following two states are alternately repeated: a state in which the image light is projected with the optical path not deflected; and a state in which the image light is projected with the pixels horizontally and vertically shifted by half the pixel interval.

JP-A-2017-191274 is an example of the related art.

However, when the detected vibration is greater than or equal to the first threshold, the projector described in JP-A-2017-191274 suppresses the vibration but does not increase the resolution of the image. The projector described in JP-A-2017-191274 is therefore capable of suppressing the image blur caused by the vibration but at the same time in capable of increasing the image resolution.

### SUMMARY

A projector according to a first aspect of the present disclosure includes an illuminator that outputs illumination light, an image formation apparatus that forms image light from the illumination light that enters the image formation apparatus, a projection optical apparatus that projects the image light formed by the image formation apparatus, an optical path shifter that is disposed in an optical path of the image light between the image formation apparatus and the projection optical apparatus and shifts the optical path of the image light with respect to a reference position where the image light is projected, a vibration detection sensor that detects vibration that affects the position where the projection optical apparatus projects the image light, and a vibration suppressor that is disposed at either a side of the optical path shifter on which the image light is incident or via which the image light exits in the optical path of the image light between the image formation apparatus and the projection optical apparatus and includes an optical member through which the image light passes. The vibration suppressor swings the optical member based on a result of detection performed by the vibration detection sensor to change the optical path of the image light that enters the optical member in a direction in which a reverse phase of a phase of the vibration is produced.

A control apparatus according to a second aspect of the present disclosure is a control apparatus of a projector including an optical path shifter that is disposed in an optical path of image light between an image formation apparatus that forms the image light from illumination light that enters the image formation apparatus and a projection optical apparatus that projects the image light, the optical path shifter shifting the optical path of the image light with respect to a reference position where the image light is projected, a vibration detection sensor that detects vibration that affects the position where the projection optical apparatus projects the image light, and a vibration suppressor that is disposed at either a side of the optical path shifter on which the image light is incident or via which the image light exits in the optical path of the image light between the image formation apparatus and the projection optical apparatus, the vibration suppressor including an optical member through which the image light passes and controlled by the control apparatus. The control apparatus acquires a result of detection performed by the vibration detection sensor, generates a vibration suppression waveform that produces a reverse phase of a phase of the vibration based on the result of the detection, and drives the vibration suppressor based on the vibration suppression waveform.

A projector according to a third aspect of the present disclosure includes an illuminator that outputs illumination light, an image formation apparatus that forms image light from the illumination light that enters the image formation apparatus, a projection optical apparatus that projects the image light formed by the image formation apparatus, an optical path shifter that includes an optical path changing member disposed in an optical path of the image light between the image formation apparatus and the projection optical apparatus and swings the optical path changing member around a swing axis that intersects with a direction in which the image light is incident to shift the optical path of the image light with respect to a reference position where the image light is projected, and a vibration detection sensor that detects vibration that affects the position where the projection optical apparatus projects the image light. The optical path shifter alternately performs pixel shift operation of shifting the optical path of the image light with respect to the reference position, and vibration suppression operation of changing the optical path of the image light that enters the optical path changing member in a direction in which a reverse phase of a phase of the vibration is produced by swinging the optical path changing member based on a result of detection performed by the vibration detection sensor.

A control apparatus according to a fourth aspect of the present disclosure is a control apparatus of a projector including an optical path shifter that is disposed in an optical path of image light between an image formation apparatus that forms the image light from illumination light that enters the image formation apparatus and a projection optical apparatus that projects the image light, the optical path shifter controlled by the control apparatus to shift the optical path of the image light with respect to a reference position where the image light is projected, and a vibration detection sensor that detects vibration that affects the position where the projection optical apparatus projects the image light. The control apparatus causes the optical path shifter to alternately perform pixel shift operation of shifting the optical path of the image light with respect to a reference position, and vibration suppression operation of generating a vibration suppression waveform that produces a reverse phase of a phase of the vibration based on a result of detection performed by the vibration detection sensor and suppressing the vibration based on the generated vibration suppression waveform.

### BRIEF DESCRIPTION OF THE DRAWINGS

FIG. 1 a schematic view showing a schematic configuration of a projector according to a first embodiment.

FIG. 2 shows an optical path shifter according to the first embodiment.

FIG. 3 describes optical path shift performed by the optical path shifter according to the first embodiment.

FIG. 4 shows a vibration suppressor according to the first embodiment.

FIG. 5 is a block diagram showing the other configurations of the projector according to the first embodiment.

FIG. 6 describes swing suppression operation performed by the vibration suppressor according to the first embodiment.

FIG. 7 describes first synchronization control performed by a control apparatus according to the first embodiment.

FIG. 8 describes second synchronization control performed by the control apparatus according to the first embodiment.

FIG. 9 is a block diagram showing the configuration of the control apparatus provided in the projector according to a second embodiment.

### DESCRIPTION OF EMBODIMENTS

### First Embodiment

A first embodiment of the present disclosure will be described below with reference to the drawings.

### Schematic Configuration of Projector

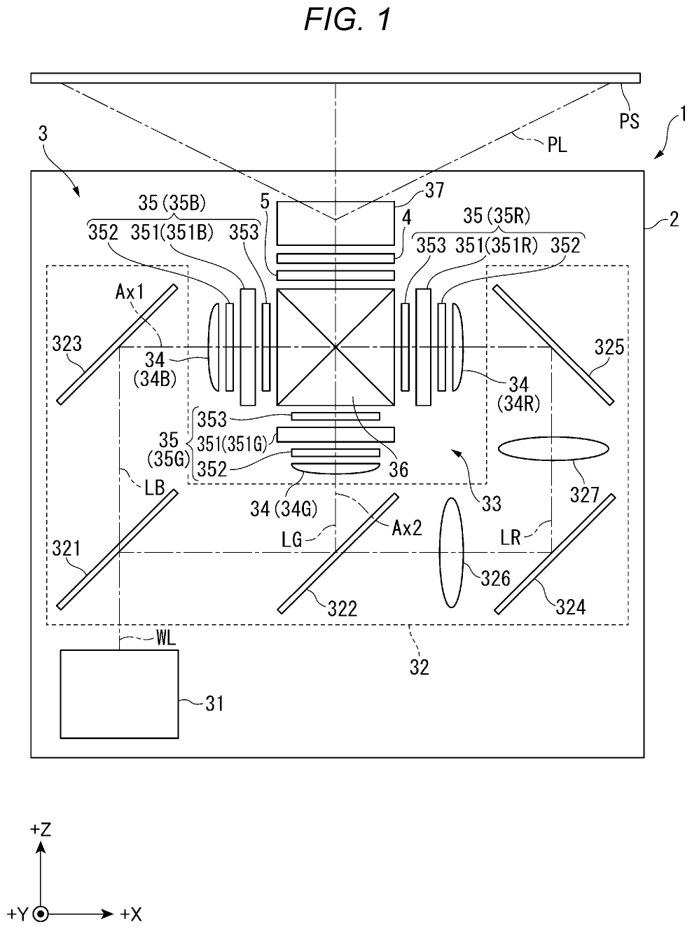

FIG. 1 a schematic view showing a schematic configuration of a projector 1 according to the present embodiment.

The projector 1 according to the present embodiment modulates light output from an illuminator 31 to form image light PL according to image information, enlarges the formed image light PL, and projects the enlarged image light PL onto a projection receiving surface PS, such as a screen, as shown in FIG. 1. The projector 1 includes an exterior enclosure 2, and an image projection unit 3 housed in the exterior enclosure 2. In addition to the components described above, the projector 1 includes, although not shown, a cooler that cools cooling targets, and a power supply that supplies electronic parts that constitute the projector 1 with electric power.

### Configuration of Image Projection Unit

The image projection unit 3 forms and projects the image light PL. The image projection unit 3 includes the illuminator 31, a color separator 32, an image formation apparatus 33, a projection optical apparatus 37, an optical path shifter 4, and a vibration suppressor 5.

It is assumed in the following description that the direction in which the illuminator 31 outputs illumination light WL is a Z-direction toward the positive end thereof, and that the direction perpendicular to the Z-direction toward the positive end thereof is an X-direction X and a Y-direction toward the positive ends thereof. It is further assumed that the opposite direction of the Z-direction toward the positive end thereof is a Z-direction toward the negative end thereof, the opposite direction of the X-direction toward the positive end thereof is an X-direction toward the negative end thereof, and that the opposite direction of the Y-direction toward the positive end thereof is a Y-direction toward the negative end thereof. It is still further assumed that an axis along the Z-direction toward the positive end thereof is a Z-axis, that the axis along the X-direction toward the positive end thereof is an X-axis, and that the axis along the Y-direction toward the positive end thereof is a Y-axis.

### Configuration of Illuminator

The illuminator 31 outputs the illumination light WL toward the positive end of the Z-direction. The configuration of the illuminator 31 may, for example, include a solid-state light emitter and a wavelength converter that converts the wavelength of the light emitted from the solid-state light emitter. The configuration of the illuminator 31 may instead, for example, include a discharge-type light emitting lamp, such as an ultrahigh-pressure mercury lamp.

### Configuration of Color Separator

The color separator 32 separates the illumination light WL incident from the illuminator 31 into three kinds of color light, blue light LB, green light LG, and red light LR. The color separator 32 includes dichroic mirrors 321 and 322, total reflection mirrors 323, 324, and 325, and relay lenses 326 and 327.

Out of the illumination light WL incident from the illuminator 31, the dichroic mirror 321 transmits the blue light LB and reflects the green light LG and the red light LR toward the positive end of the X-direction.

Out of the green light LG and the red light LR separated by the dichroic mirror 321, the dichroic mirror 322 reflects the green light LG toward the positive end of the Z-direction, and transmits the red light LR toward the positive end of the X-direction. The green light LG reflected off the dichroic mirror 322 enters a green light modulation module 35G provided in the image formation apparatus 33.

The total reflection mirror 323 reflects the blue light LB having passed through the dichroic mirror 321 toward the positive end of the X-direction. The blue light LB reflected off the total reflection mirror 323 enters a blue light modulation module 35B provided in the image formation apparatus 33.

The total reflection mirror 324 reflects the red light LR having passed through the dichroic mirror 322 toward the positive end of the Z-direction.

The total reflection mirror 325 reflects the red light LR reflected off the total reflection mirror 324 toward the negative end of the X-direction. The red light LR reflected off the total reflection mirror 325 enters a red light modulation module 35R provided in the image formation apparatus 33.

The relay lens 326 is disposed between the dichroic mirror 322 and the total reflection mirror 324 in the optical path of red light LR, and the relay lens 327 is disposed between the total reflection mirror 324 and the total reflection mirror 325 in the optical path of red light LR. The relay lenses 326 and 327 compensate for the optical loss of the red light LR due to the fact that the optical path of the red light LR is longer than the optical path of blue light LB and the optical path of green light LG.

### Configuration of Image Formation Apparatus

The image formation apparatus 33 separately modulates the incident blue light LB, green light LG, and red light LR, and combines the modulated color light LB, color light LG, and color light LR with one another to form the image light PL to be projected by the projection optical apparatus 37. The image formation apparatus 33 includes field lenses 34, the light modulation modules 35, and a light combiner 36.

### Configuration of Field Lenses

The field lenses 34 each parallelize the light incident thereon. The image formation apparatus 33 includes three field lenses 34. The three field lenses 34 include a field lens 34B provided in the optical path of the blue light LB, a field lens 34G provided in the optical path of the green light LG, and a field lens 34R provided in the optical path of the red light LR. The color light LR having passed through the field lens 34R enters the light modulation module 35 dedicated for the color light, so do the color light LG having passed through the field lens 34G, and the color light LB having passed through the field lens 34B.

### Configuration of Light Modulation Modules

The light modulation modules 35 each modulate color light incident thereon to form image light according to image information, and outputs the formed image light to the light combiner 36. The image formation apparatus 33 includes three light modulation modules 35. The three light modulation modules 35 include the blue light modulation module 35B, which modulates the blue light LB and outputs blue image light, the green light modulation module 35G, which modulates the green light LG and outputs green image light, and the red light modulation module 35R, which modulates the red light LR and outputs red image light.

The light modulation modules 35 each include a light modulator 351, a light-incident-side polarizer 352, and a light-exiting-side polarizer 353.

Specifically, the blue light modulation module 35B includes a blue light modulator 351B, which modulates the blue light LB, the light-incident-side polarizer 352, which is disposed on the light incident side of the blue light modulator 351B, and the light-exiting-side polarizer 353, which is disposed on the light exiting side of the blue light modulator 351B. The blue light modulation module 35B outputs the blue image light toward the positive end of the X-direction.

The green light modulation module 35G includes a green light modulator 351G, which modulates the green light LG, the light-incident-side polarizer 352, and the light-exiting-side polarizer 353. The green light modulation module 35G outputs the green image light toward the positive end of the Z-direction.

The red light modulation module 35R includes a red light modulator 351R, which modulates the red light LR, the light-incident-side polarizer 352, and the light-exiting-side polarizer 353. The red light modulation module 35R outputs the red image light toward the negative end of the X-direction.

In the present embodiment, the light modulators 351 are each formed of a liquid crystal panel, and the light modulation modules 35 are each a liquid crystal light valve including the light modulator 351, the light-incident-side polarizers 352, and the light-exiting-side polarizers 353.

### Configuration of Light Combiner

The light combiner 36 combines the blue image light incident from the blue light modulation module 35B, the green image light incident from the green light modulation module 35G, and the red image light incident from the red light modulation module 35R with one another to form the image light PL, and outputs the formed image light PL toward the vibration suppressor 5. That is, the light combiner 36 outputs the formed image light PL toward the projection optical apparatus 37.

In the present embodiment, the light combiner 36 is formed of a cross dichroic prism having a substantially cuboidal shape, but not necessarily. The light combiner 36 may be formed, for example, of a plurality of dichroic mirrors.

### Configuration of Projection Optical Apparatus

The projection optical apparatus 37 projects the image light PL incident from the light combiner 36 of the image formation apparatus 33 via the optical path shifter 4 and the vibration suppressor 5 onto the projection receiving surface PS. Although not shown, the projection optical apparatus 37 can, for example, be a unit lens including a plurality of lenses and a lens barrel that holds the plurality of lenses.

In the present specification, note that an image formed by the image light PL projected by the projection optical apparatus 37 and displayed on the projection receiving surface PS is called a projection image.

### Configuration of Optical Path Shifter

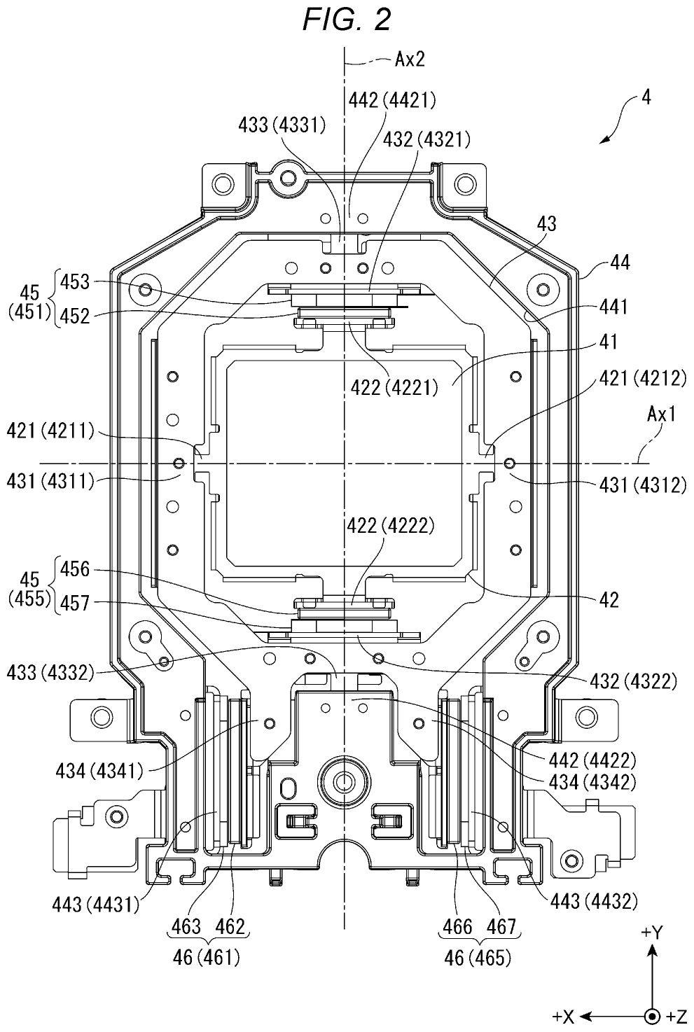

FIG. 2 shows the optical path shifter 4 viewed from the light exiting side.

The optical path shifter 4 is disposed between the light combiner 36 of the image formation apparatus 33 and the projection optical apparatus 37. The optical path shifter 4 shifts the optical path of the image light PL output from the light combiner 36 and entering the projection optical apparatus 37 to increase the resolution of the projection image formed by the image light PL.

The optical path shifter 4 includes an optical path changing member 41, a first movable section 42, a second movable section 43, a base 44, a first driver 45, and a second driver 46, as shown in FIG. 2.

### Configuration of Optical Path Changing Member

The optical path changing member 41 is a light transmissive substrate, such as a glass substrate. The optical path changing member 41 is disposed in the optical path of the image light PL between the light combiner 36 and the projection optical apparatus 37, and the image light PL enters the optical path changing member 41 from the light combiner 36. The optical path changing member 41 is tilted by the drivers 45 and 46 with respect to an imaginary plane perpendicular to the light exiting optical axis of the light combiner 36, so that the optical path changing member 41 refracts the image light PL to shift the optical path thereof.

In the present embodiment, one of a first axis Ax1 and a second axis Ax2, which are swing axes of the optical path changing member 41, corresponds to a first swing axis, and the other axis corresponds to a second swing axis. The first axis Ax1 is an axis along the X-axis, and the second axis Ax2 is an axis along the Y-axis.

### Configuration of First Movable Section

The first movable section 42 is formed in the shape of a rectangular frame, holds the optical path changing member 41, and further holds first magnets 452 and 456 of the first driver 45. The first movable section 42 is supported by the second movable section 43 so as to be swingable around the first axis Ax1. The first movable section 42 includes a shaft section 421 and a fixing section 422.

The shaft section 421 includes a shaft section 4211, which protrudes from an outer circumferential portion of the first movable section 42 toward the positive end of the X-direction and a shaft section 4212, which protrudes from an outer circumferential portion of the first movable section 42 toward the negative end of the X-direction. The shaft sections 4211 and 4212 are inserted into the second movable section 43, so that the first movable section 42 is supported by the second movable section 43 so as to be swingable around the first axis Ax1. That is, the extension of the center axis of the shaft section 4211 and the extension of the center axis of the shaft section 4212 coincides with each other, and the extensions of the center axes of the shaft sections 4211 and 4212 form the first axis Ax1 along the X-axis.

The fixing section 422 includes a fixing section 4221, which protrudes from an outer circumferential portion of the first movable section 42 toward the positive end of the Y-direction, and a fixing section 4222, which protrudes from an outer circumferential portion of the first movable section 42 toward the negative end of the Y-direction. The first magnet 452 of the first driver 45 is fixed to the front end of the fixing section 4221, and the first magnet 456 of the first driver 45 is fixed to the front end of the fixing section 4222. The fixing sections 4221 and 4222 function as yokes for the first magnets 452 and 456.

### Configuration of Second Movable Section

The second movable section 43 is formed in the shape of a rectangular frame, holds the first movable section 42 so as to be swingable around the first axis Ax1, and further holds first coils 453 and 457 of the first driver 45 and second magnets 462 and 466 of the second driver 46. The second movable section 43 includes a rotation support section 431, a support section 432, a shaft section 433, and an arm section 434.

The rotation support section 431 includes a rotation support section 4311 provided at an inner edge of the second movable section 43 that is the inner edge facing the negative end of the X-direction, and a rotation support section 4312 provided at an inner edge of the second movable section 43 that is the inner edge facing the positive end of the X-direction. The rotation support section 4311 rotatably supports the shaft section 4211, and the rotation support section 4312 rotatably supports the shaft section 4212. The first movable section 42 is thus supported by the second movable section 43 so as to be swingable around the first axis Ax1.

The support section 432 includes a support section 4321 provided at an inner edge of the second movable section 43 that is the inner edge facing the negative end of the Y-direction, and a support section 4322 provided at an inner edge of the second movable section 43 that is the inner edge facing the positive end of the Y-direction. The support section 4321 supports the first coil 453 of the first driver 45, and the support section 4322 supports the first coil 457 of the first driver 45.

The shaft section 433 includes a shaft section 4331, which protrudes from an outer circumferential portion of the second movable section 43 toward the positive end of the Y-direction, and a shaft section 4332, which protrudes from an outer circumferential portion of the second movable section 43 toward the negative end of the Y-direction. The shaft sections 4331 and 4332 are inserted into the base 44, so that the second movable section 43 is supported by the base 44 so as to be swingable around the second axis Ax2. The extension of the center axis of the shaft section 4331 and the extension of the center axis of the shaft section 4332 coincides with each other, and the extensions of the center axes of the shaft sections 4331 and 4332 form the second axis Ax2.

The arm section 434 is a portion protruding from the second movable section 43 toward the negative end of the Y-direction. The arm section 434 includes an arm section 4341 provided to face the positive end of the X-direction, and an arm section 4342 provided to face the negative end of the X-direction. The second magnet 462 of the second driver 46 is fixed to the arm section 4341, and the second magnet 466 of the second driver 46 is fixed to the arm section 4342.

### Configuration of Base

The base 44 is formed in the shape of a frame having an opening 441 according to the outer shape of the second movable section 43. The base 44 holds the second movable section 43 so as to be swingable around the second axis Ax2 and further holds second coils 463 and 467 of the second driver 46. The base 44 includes a rotation support section 442 and a support section 443.

The rotation support section 442 includes a rotation support section 4421 provided at an inner edge of the base 44 that is the inner edge facing toward the negative end of the Y-direction, and a rotation support section 4422 provided at an inner edge of the base 44 that is the inner edge facing the positive end of the Y-direction. The rotation support section 4421 rotatably supports the shaft section 4331, and the rotation support section 4422 rotatably supports the shaft section 4332. The second movable section 43 is thus supported by the base 44 so as to be swingable around the second axis Ax2.

The support section 443 includes a support 4431 provided at an inner edge of the second movable section 43 that is the inner edge facing the negative end of the X-direction, and a support section 4432 provided at an inner edge of the second movable section 43 that is the inner edge facing the positive end of the X-direction. The support section 4431 supports the second coil 463 of the second driver 46, and the support section 4432 supports the second coil 467 of the second driver 46.

### Configuration of First Driver

The first driver 45 swings the optical path changing member 41 around the first axis Ax1 by swinging the first movable section 42 around the first axis Ax1. The first driver 45 includes a first actuator 451 and a second actuator 455, which are disposed at positions on the second axis Ax2 symmetrically with respect to the first axis Ax1.

The first actuator 451 is shifted from the first axis Ax1 toward the positive end of the Y-direction, and the second actuator 455 is shifted from the first axis Ax1 toward the negative end of the Y-direction.

The first actuator 451 is a voice coil motor including the first magnet 452 fixed to the first movable section 42 and the first coil 453 supported by the second movable section 43.

The second actuator 455 is a voice coil motor including the first magnet 456 fixed to the first movable section 42 and the first coil 457 supported by the second movable section 43.

A control apparatus 7, which will be described later, supplies the first coils 453 and 457 with alternating currents of reverse phases, so that the optical path changing member 41 held by the first movable section 42 swings around the first axis Ax1.

### Configuration of Second Driver

The second driver 46 swings the optical path changing member 41 around the second axis Ax2, which is perpendicular to the first axis Ax1, by swinging the second movable section 43.

The second actuator 46 includes a first actuator 461 and a second actuator 465, which are shifted from the first axis Ax1 toward the negative end of the Y-direction and disposed symmetrically with respect to the second axis Ax2.

The first actuator 461 is shifted from the second axis Ax2 toward the positive end of the X-direction, and the second actuator 465 is shifted from the second axis Ax2 toward the negative end of the X-direction.

The first actuator 461 is a voice coil motor including the second magnet 462 fixed to the second movable section 43 and the second coil 463 supported by the base 44.

The second actuator 465 is a voice coil motor including the second magnet 466 fixed to the second movable section 43 and the second coil 467 supported by the base 44.

The control apparatus 7, which will be described later, supplies the second coils 463 and 467 with alternating currents of reverse phases, so that the second movable section 43 swings around the second axis Ax2 relative to the base 44, and the optical path changing member 41 therefore swings around the second axis Ax2.

### Optical Path Shift Performed by Optical Path Shifter

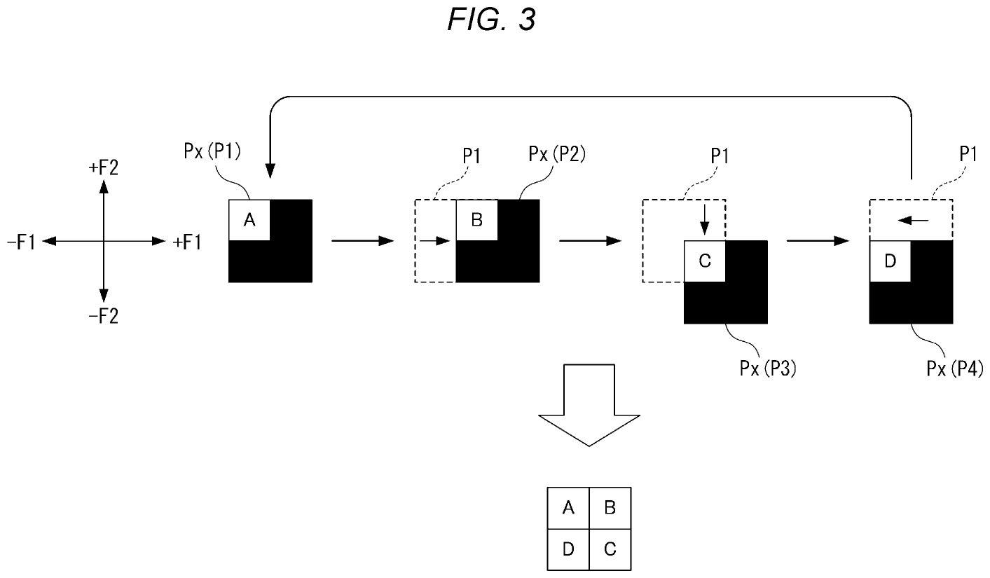

FIG. 3 describes the optical path shift of the image light performed by the optical path shifter 4.

The increase in the resolution of the projection image achieved by the optical path shifter 4 will now be described.

As described above, the optical path shifter 4 changes the posture of the optical path changing member 41, through which the image light PL passes, to shift the optical path of the image light PL with the aid of refraction that occurs in the optical path changing member 41.

Note that an F1-direction toward the positive end thereof and an F2-direction toward the positive end thereof shown in FIG. 3 are directions perpendicular to each other at the projection receiving surface PS, that an F1-direction toward the negative end thereof is the opposite direction of the F1-direction toward the positive end thereof, and that an F2-direction toward the negative end thereof is the opposite direction of the F2-direction toward the positive end thereof.

Specifically, the optical path shifter 4 shifts the optical path of the image light toward the positive and negative ends of the Y-direction and toward the positive and negative ends of the X-direction by swinging the optical path changing member 41 in two directions, a first swing direction around the first axis Ax1 and a second swing direction around the second axis Ax2. Each pixel Px of the projection image displayed at the projection receiving surface PS is therefore displaced toward the positive and negative ends of the F1-direction and toward the positive and negative ends of the F2-direction, as shown in FIG. 3.

The control apparatus 7, which will be described later, causes the optical path shifter 4 to combine the pixel shift toward the positive and negative ends of the F1-direction and the pixel shift toward the positive and negative ends of the F2-direction with each other to increase the apparent number of pixels and hence increase the resolution of the projection image.

For example, the control apparatus 7 causes the optical path shifter 4 to shift the optical path of the image light to move the pixel Px to a position displaced by half a pixel toward the positive and negative ends of the F1-direction and toward the positive and negative ends of the F2-direction. The term “half a pixel” indicates half of the size of the pixel Px.

The position where the pixel Px is displayed on the projection receiving surface PS is thus shifted to a second position P2 displaced by half a pixel from a first position P1 toward the positive end of the F1-direction, to a third position P3 displaced by half a pixel from the second position P2 toward the negative end of the F2-direction, and to a fourth position P4 displaced by half a pixel from the first position P1 toward the negative end of the F2-direction. The second position P2, the third position P3, and the fourth position P4 correspond to positions shifted from the first position P1. Note that the position where the projection image is displayed when the pixel Px is displayed at the first position P1 is a reference position.

The control apparatus 7 causes the optical path shifter 4 to shift the optical path of the image light PL in such a way that the pixel Px is displayed at each of the positions P1, P2, P3, and P4 for a predetermined period of time to change the contents displayed by the light modulation modules 35R, 35G, and 35B in synchronization with the optical path shift. Pixels A, B, C, and D each having a size smaller than the size of the pixel Px can therefore be apparently displayed.

For example, to display the pixels A, B, C, and D as a whole at a frequency of 60 Hz, the contents displayed at the light modulators 351R, 351G, and 351B need to be switched at the frequency four times higher than 60 Hz in correspondence with the positions P1, P2, P3, and P4. In this case, a projection image having apparently high resolution can be displayed by setting the refresh rate of each of the light modulators 351 to 240 Hz and causing the light modulator 351 to successively form image light containing the pixel A to be displayed at the first position P1, image light containing the pixel B to be displayed at the second position P2, image light containing the pixel C to be displayed at the third position P3, and image light containing the pixel D to be displayed at the fourth position P4.

In the example of the pixel shift shown in FIG. 3, the F1-directions toward the positive and negative ends thereof and the F2-directions toward the positive and negative ends thereof are the directions in which the pixels Px displayed in a matrix on the projection receiving surface PS are arranged. The F1-directions toward the positive and negative ends thereof and the F2-directions toward the positive and negative ends thereof, however, may not be perpendicular to each other and may incline with respect to the directions in which the pixels Px are arranged. Even when the shift directions described above are employed, combining the optical path shift in the F1-directions toward the positive and negative ends thereof and the F2-directions toward the positive and negative ends thereof with each other as appropriate allows movement of each of the pixels Px to the positions P1, P2, P3, and P4. The amount of displacement of each of the positions P2 to P4 from the first position P1 is not limited to half a pixel, and may, for example, be ¼ or ¾ of each of the pixels Px.

### Configuration of Vibration Suppressor

The vibration suppressor 5 is disposed in the optical path of the image light PL between the light combiner 36 of the image formation apparatus 33 and the projection optical apparatus 37, as shown in FIG. 1. The vibration suppressor 5 changes the optical path of the image light PL output from the light combiner 36 under the control of the control apparatus 7, as the optical path shifter 4 does. In detail, the vibration suppressor 5 changes the optical path of the image light PL in the direction in which the reverse phase of the phase of vibration detected by a vibration detection sensor 6, which will be described later, is produced.

In the present embodiment, the vibration suppressor 5 is disposed on the light exiting side of the light combiner 36 and on the light incident side of the optical path shifter 4, but not necessarily. The vibration suppressor 5 may instead be disposed on the light exiting side of the optical path shifter 4 and on the light incident side of the projection optical apparatus 37.

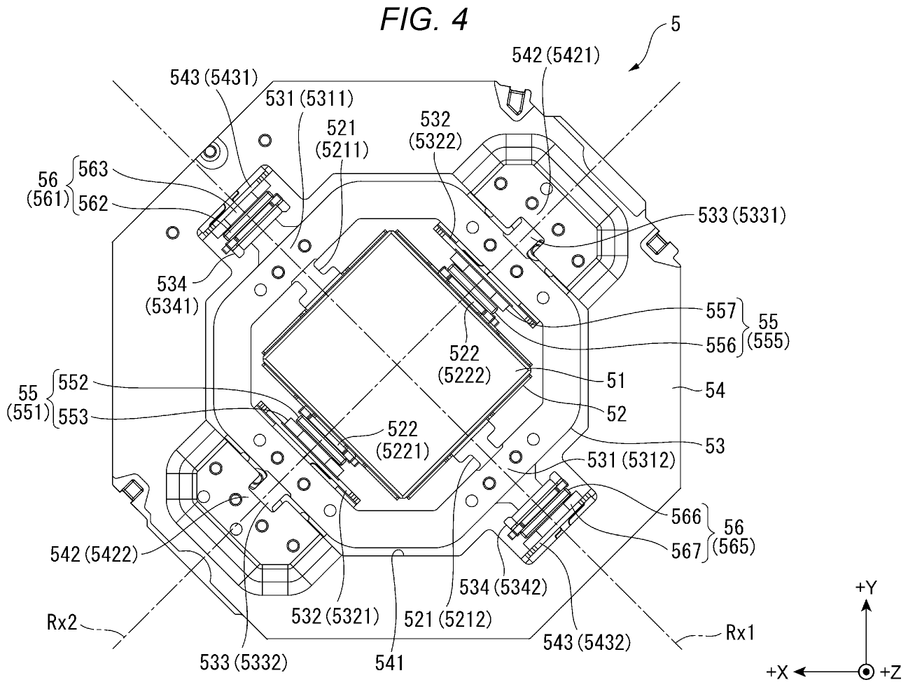

FIG. 4 shows the vibration suppressor 5 viewed from the light exiting side.

The vibration suppressor 5 includes an optical member 51, through which the image light passes, and changes the optical path of the image light having entered the optical member 51 in the opposite direction of the direction in which the projection image at the projection receiving surface PS moves due to the vibration to suppress swing motion of the projection image at the projection receiving surface PS by causing the optical member 51 to incline with respect to the imaginary plane perpendicular to the light exiting optical axis of the light combiner 36.

The configuration of the vibration suppressor 5 is the same as that of the optical path shifter 4. That is, the vibration suppressor 5 includes the optical member 51, a first movable section 52, a second movable section 53, a base 54, a first driver 55, and a second driver 56, as shown in FIG. 4.

The optical member 51 is a light transmissive substrate, such as a glass substrate, as the optical path changing member 41 is. The optical member 51 is disposed in the optical path of the image light PL between the light combiner 36 and the projection optical apparatus 37, and the image light PL enters the optical member 51 from the light combiner 36. The optical member 51 is tilted by the drivers 55 and 56 with respect to the imaginary plane perpendicular to the light exiting optical axis of the light combiner 36, so that the optical member 51 refracts the image light PL to shift the optical path thereof.

### Configuration of First Movable Section

The first movable section 52 is formed in the shape of a rectangular frame, holds the optical member 51, and further holds first magnets 552 and 556 of the first driver 55. The first movable section 52 is supported by the second movable section 53 so as to be swingable around a first swing axis Rx1. The first movable section 52 includes a linkage section 521 and a fixing section 522.

Note that the first swing axis Rx1 is perpendicular to the Z-axis and intersects with the X-axis and the Y-axis. That is, when the projector 1 is provided so that at the Y-axis extends along the vertical direction and the X-axis extends along the horizontal direction, the first swing axis Rx1 intersects with the vertical direction. In detail, the first swing axis Rx1 intersects with an imaginary plane containing the vertical direction and the optical axis direction in which the image light passes. In other words, the first swing axis Rx1 intersects with a YZ-plane defined by the vertical direction and the optical axis along which the image formation apparatus 33 outputs the image light.

The linkage section 521 is a section linked to the second movable section 53. The linkage section 521 includes a linkage section 5211, which protrudes from an outer circumferential portion of the first movable section 52 toward the positive ends of the X-direction and the Y-direction, and a linkage section 5212, which protrudes from an outer circumferential portion of the first movable section 52 toward the negative ends of the X-direction and the Y-direction. The linkage sections 5211 and 5212, which bend, allow the first movable section 52 to swing around the first swing axis Rx1 relative to the second movable section 53. Note that the linkage sections 5211 and 5212 are disposed on the first swing axis Rx1.

The fixing section 522 includes a fixing section 5221 provided at a surface of the outer circumferential portion of the first movable section 52, the surface facing the positive end of the X-direction and the negative end of the Y-direction, and a fixing section 5222 provided at a surface of the outer circumferential portion of the first movable section 52, the surface facing the negative end of the X-direction and the positive end of the Y-direction. The first magnet 552 of the first driver 55 is fixed to the fixing section 5221, and the first magnet 556 of the first driver 55 is fixed to the fixing section 5222. The fixing sections 5221 and 5222 function as yokes for the first magnets 552 and 556.

### Configuration of Second Movable Section

The second movable section 53 holds the first movable section 52 so as to be swingable around the first swing axis Rx1 and further holds first coils 553 and 557 of the first driver 55 and second magnets 562 and 566 of the second driver 56. The second movable section 53 is supported by the based 54 so as to be swingable around the second swing axis Rx2.

Note that the second swing axis Rx2 is perpendicular to the Z-axis and intersects with the X-axis and the Y-axis. That is, when the projector 1 is so installed that the Y-axis extends along the vertical direction and the X-axis extends along the horizontal direction, the second swing axis Rx2 intersects with the vertical direction. In detail, the second swing axis Rx2 intersects with the imaginary plane containing the vertical direction and the optical axis direction in which the image light passes. In other words, the second swing axis Rx2 intersects with the YZ-plane defined by the vertical direction and the optical axis along which the image formation apparatus 33 outputs the image light.

The second movable section 53 includes a swing support section 531, a support section 532, a shaft section 533, and a fixing section 534.

The swing support section 531 includes a swing support section 5311 provided at an inner edge of the second movable section 53 that is the inner edge facing the negative ends of the X-direction and the Y-direction, and a swing support section 5312 provided at an inner edge of the second movable section 53 that is the inner edge facing the positive ends of the X-direction and the Y-direction. The linkage section 5211 is linked to the swing support section 5311, and the linkage section 5212 is linked to the swing support section 5312. The first movable section 52 is thus supported by the second movable section 53.

The support section 532 includes a support section 5321 provided at an inner edge of the second movable section 53 that is the inner edge facing the negative end of the X-direction and the positive end of the Y-direction, and a support section 5322 provided at an inner edge of the second movable section 53 that is the inner edge facing the positive end of the X-direction and the negative end of the Y-direction. The support section 5321 supports the first coil 553 of the first driver 55, and the support section 5322 supports the first coil 557 of the first driver 55.

The shaft section 533 includes a shaft section 5331, which protrudes from an outer circumferential portion of the second movable section 53 toward the negative end of the X-direction and toward the positive end of the Y-direction, and a shaft section 5332, which protrudes from an outer circumferential portion of the second movable section 53 toward the positive end of the X-direction and toward the negative end of the Y-direction. The shaft sections 5331 and 5332 are supported by the base 54, so that the second movable section 53 is supported by the base 54 so as to be swingable around the second swing axis Rx2. The extension of the center axis of the shaft section 5331 and the extension of the center axis of the shaft section 5332 coincides with each other, and the extensions of the center axes of the shaft sections 5331 and 5332 form the second swing axis Rx2.

The fixing section 534 includes a fixing section 5341, which protrudes from an outer circumferential portion of the second movable section 53 toward the positive ends of the X-direction and the Y-direction, and a fixing section 5342, which protrudes from an outer circumferential portion of the second movable section 53 toward the negative ends of the X-direction and the Y-direction. The second magnet 562 of the second driver 56 is fixed to the fixing section 5341, and the second magnet 566 of the second driver 56 is fixed to the fixing section 5342. The fixing sections 5341 and 5342 function as yokes for the magnets 562 and 566, respectively.

### Configuration of Base

The base 54 is a substantially octagonal frame when viewed from the light exiting side of the vibration suppressor 5. The base 54 holds the second movable section 53 so as to be swingable around the second swing axis Rx2 and further holds second coils 563 and 567 of the second driver 56.

The base 54 has an opening 541, through which the image light passes. The opening 541 is formed in a shape according to the outer shape of the second movable section 53, and the second movable section 53 that holds the first movable section 52 is disposed in the opening 541.

The base 54 further includes a rotation support section 542 and a support section 543.

The rotation support section 542 includes a rotation support 5421 provided at an inner edge of the opening 541 that is the inner edge facing the positive end of the X-direction and the negative end of the Y-direction, and a rotation support 5422 provided at an inner edge of the opening 541 that is the inner edge facing the negative end of the X-direction and the positive end of the Y-direction. The rotation support 5421 rotatably supports the shaft section 5331, and the rotation support 5422 rotatably supports the shaft section 5332. The second movable section 53 is thus supported so as to be swingable around the second swing axis Rx2.

The support section 543 includes a support section 5431 provided at an inner edge of the opening 541 that is the inner edge facing the negative ends of the X-direction and the Y-direction, and a support section 5432 provided at an inner edge of the opening 541 that is the inner edge facing the positive ends of the X-direction and the Y-direction. The support section 5431 supports the second coil 563, and the support section 5432 supports the second coil 567.

### Configuration of First Driver

The first driver 55 swings the optical member 51 around the first swing axis Rx1 by swinging the first movable section 52 around the first swing axis Rx1.

The configuration of the first driver 55 is the same as that of the first driver 45 of the optical path shifter 4. That is, the first driver 55 includes a first actuator 551 and a second actuator 555 disposed at positions on the second swing axis Rx2 symmetrically with respect to the first swing axis Rx1, and the first actuator 551 and the second actuator 555 swing the optical member 51 held by the first movable section 52 around the first swing axis Rx1.

The first actuator 551 is disposed at a position shifted from the first swing axis Rx1 toward the positive end of the X-direction and the negative end of the Y-direction. The first actuator 551 is a voice coil motor including the first magnet 552 fixed to the first movable section 52 and the first coil 553 supported by the second movable section 53.

The second actuator 555 is disposed at a position shifted from the first swing axis Rx1 toward the negative end of the X-direction and the positive end of the Y-direction. The second actuator 555 is a voice coil motor including the first magnet 556 fixed to the first movable section 52 and the first coil 557 supported by the second movable section 53.

The control apparatus 7, which will be described later, supplies the first coils 553 and 557 with alternating currents of reverse phases, so that the optical member 51 held by the first movable section 52 swings around the first swing axis Rx1.

### Configuration of Second Driver

The second driver 56 swings the optical member 51 around the second swing axis Rx2 by swinging the second movable section 53 around the second swing axis Rx2.

The configuration of the second driver 56 is the same as that of the second driver 46 of the optical path shifter 4. That is, the second driver 56 includes a first actuator 561 and a second actuator 565 disposed at positions on the first swing axis Rx1 symmetrically with respect to the second swing axis Rx2, and the first actuator 561 and the second actuator 565 swing the first movable section 52 held by the second movable section 53 and in turn the optical member 51 held by the first movable section 52 around the second swing axis Rx2.

The first actuator 561 is disposed at a position shifted from the second swing axis Rx2 toward the positive ends of the X-direction and the Y-direction. The first actuator 561 is a voice coil motor including the second magnet 562 fixed to the second movable section 53 and the second coil 563 supported by the base 54.

The second actuator 565 is disposed at a position shifted from the second swing axis Rx2 toward the negative ends of the X-direction and the Y-direction. The second actuator 565 is a voice coil motor including the second magnet 566 fixed to the second movable section 53 and the second coil 567 supported by the base 54.

The control apparatus 7, which will be described later, supplies the second coils 563 and 567 with alternating currents of reverse phases, so that the first movable section 52 held by the second movable section 53 swings, and the optical member 51 in turn swings around the second swing axis Rx2.

Note that the first swing axis Rx1 and the second swing axis Rx2 of the vibration suppressor 5 do not coincide with the first axis Ax1 and the second axis Ax2 of the optical path shifter 4, respectively, and incline by 45° with respect to the first axis Ax1 and the second axis Ax2.

### Other Configurations of Projector

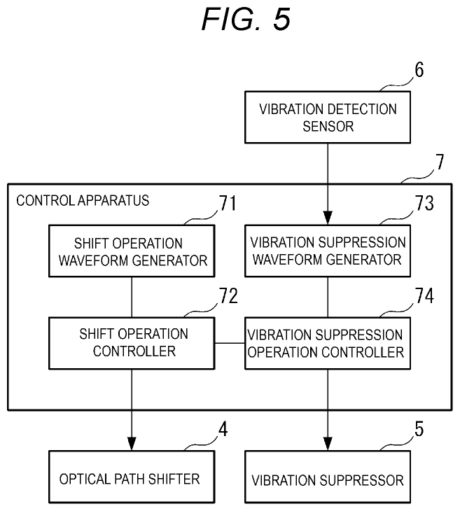

FIG. 5 is a block diagram showing the other configurations of the projector 1.

The projector 1 further includes the vibration detection sensor 6 and the control apparatus 7, as shown in FIG. 5.

### Configuration of Vibration Detection Sensor

The vibration detection sensor 6 detects vibration that affects the position where the projection optical apparatus 37 projects the image light PL. For example, the vibration detection sensor 6 detects the vibration direction and amplitude of the vibration acting on the projector 1. Examples of the vibration detection sensor 6 described above may include an acceleration sensor and a gyro sensor.

An example of the position where the vibration detection sensor 6 is disposed may include the front end of the projection optical apparatus 37.

### Configuration of Control Apparatus

The control apparatus 7 controls the operation of the projector 1. For example, the control apparatus 7 controls the turning on and off the illuminator 31, and causes each of the light modulators 351 to form image light according to an image signal based on the incident illumination light.

Furthermore, the control apparatus 7 controls the optical path shifter 4 to cause the optical path shifter 4 to shift the optical path of the image light PL as described above, and further controls the operation of the vibration suppressor 5 based on the result of detection performed by the vibration detection sensor 6. That is, the control apparatus 7 controls the operation of the vibration suppressor 5.

The control apparatus 7 includes a shift operation waveform generator 71, a shift operation controller 72, a vibration suppression waveform generator 73, and a vibration suppression operation controller 74, as shown in FIG. 5.

The shift operation waveform generator 71 generates a shift operation waveform used to operate the optical path shifter 4. Specifically, the shift operation waveform generator 71 generates a shift operation waveform used to cause the optical path shifter 4 to move the position where each of the pixels Px contained in the projection image is projected to the first position P1, the second position P2, the third position P3, and the fourth position P4 in this order in a predetermined cycle.

The shift operation controller 72 operates the optical path shifter 4 based on the shift operation waveform generated by the shift operation waveform generator 71. That is, the shift operation controller 72 causes the optical path shifter 4 to perform the pixel shift operation of shifting the optical path of the image light PL with respect to the reference position on the projection receiving surface PS. The position of the projection image on the projection receiving surface PS is thus sequentially moved, so that the resolution of the projection image is improved in a pseudo manner.

The vibration suppression waveform generator 73 acquires the result of detection performed by the vibration detection sensor 6 and generates a vibration suppression waveform used by the vibration suppressor 5 to reduce the vibration detected by the vibration detection sensor 6. Specifically, the vibration suppression waveform generator 73 generates a waveform having the reverse phase of the phase of the vibration detected by the vibration detection sensor 6 as the vibration suppression waveform.

The vibration suppression operation controller 74 operates the vibration suppressor 5 based on the vibration suppression waveform generated by the vibration suppression waveform generator 73 to reduce the vibration that affects the position where the image light projected by the projection optical apparatus 37 is projected. Specifically, the vibration suppression operation controller 74 performs swing suppression operation of causing the first driver 55 and the second driver 56 of the vibration suppressor 5 to swing the optical member 51 based on the vibration suppression waveform to change the optical path of image light that enters the optical member 51 in the direction in which the reverse phase of the phase of the detected vibration is produced. The optical path of the image light PL is thus shifted in the opposite direction of the direction of the vibration, so that the vibration of the projection image at the projection receiving surface PS is suppressed.

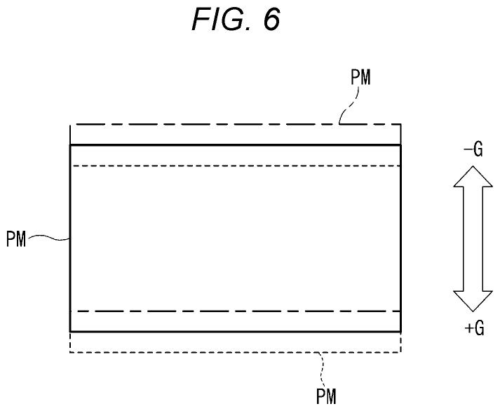

FIG. 6 describes the swing suppression operation performed by the vibration suppressor 5.

For example, when aa projected image PM on the projection receiving surface PS moves toward the positive end of a G-direction due to the vibration acting on the projector 1, the vibration suppression operation controller 74 drives the vibration suppressor 5 to change the optical path of the image light PL toward the negative end of the G direction, as shown in FIG. 6. On the other hand, when the projection image PM moves toward the negative end of the G-direction due to the vibration, the vibration suppression operation controller 74 drives the vibration suppressor 5 to change the optical path of the image light PL toward the positive end of the G direction.

Therefore, even when vibration acts on the projector 1, the projection image PM can be displayed at the position where the projection image PM is displayed at the projection receiving surface PS when no vibration acts on the projector 1.

The thus configured control apparatus 7, which causes the optical path shifter 4 and the vibration suppressor 5 to operate independently of each other, can improve the resolution of the projection image PM in a pseudo manner, and suppress the swing motion of the projection image PM at the projection receiving surface.

### Synchronization Control of Optical Path Shifter and Vibration Suppressor

Note that the control apparatus 7 may synchronize the optical path shift operation performed by the shift operation controller 72 and the vibration suppression operation performed by the vibration suppression operation controller 74 with each other, as will be described below.

### First Synchronization Control

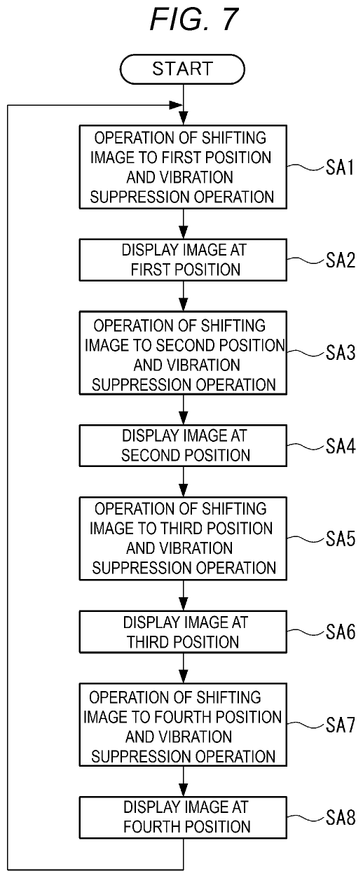

FIG. 7 describes first synchronization control performed by the control apparatus 7 to synchronize the optical path shifter 4 and the vibration suppressor 5 with each other.

For example, in synchronization with the timing at which the optical path shifter 4 performs the optical path shift operation, the control apparatus 7 may perform the first synchronization control in which the vibration suppression operation controller 74 causes the vibration suppressor 5 to perform the vibration suppression operation based on the vibration suppression waveform, as shown in FIG. 7. That is, in the first synchronization control, the vibration suppression operation is performed at the same timing at which the optical path shift operation is performed.

Specifically, in the first synchronization control, the vibration suppression operation controller 74 performs the vibration suppression operation based on the vibration suppression waveform at the same timing at which the optical path shift operation of shifting the optical path of the image light is so performed that the projection image is displayed at the first position P1 (step SA1).

The shift operation controller 72 then stops the optical path shift operation, and the vibration suppression operation controller 74 stops the vibration suppression operation. The projection image is thus displayed at the first position (step SA2).

After step SA2, the shift operation controller 72 performs the optical path shift operation of displaying the image at the second position P2, and the vibration suppression operation controller 74 performs the vibration suppression operation (step SA3). The projection image is thus displayed at the second position P2 (step SA4).

After step SA4, the shift operation controller 72 performs the optical path shift operation of displaying the image at the third position P3, and the vibration suppression operation controller 74 performs the vibration suppression operation (step SA5). The projection image is thus displayed at the third position P3 (step SA6).

After step SA6, the shift operation controller 72 performs the optical path shift operation of displaying the image at the fourth position P4, and the vibration suppression operation controller 74 performs the vibration suppression operation (step SA7). The projection image is thus displayed at the fourth position P4 (step SA8).

The control apparatus 7 then return to step SA1, and performs the vibration suppression operation at the timing at which the optical path shift operation is performed. In the present embodiment, the refresh rate at which the light modulators 351 each generate an image to be displayed at each position on the projection receiving surface PS is 240 Hz, so that steps SA1 and SA2, steps SA3 and SA4, steps SA5 and SA6, and steps SA7 and SA8 are successively executed at 240 Hz.

### Second Synchronization Control

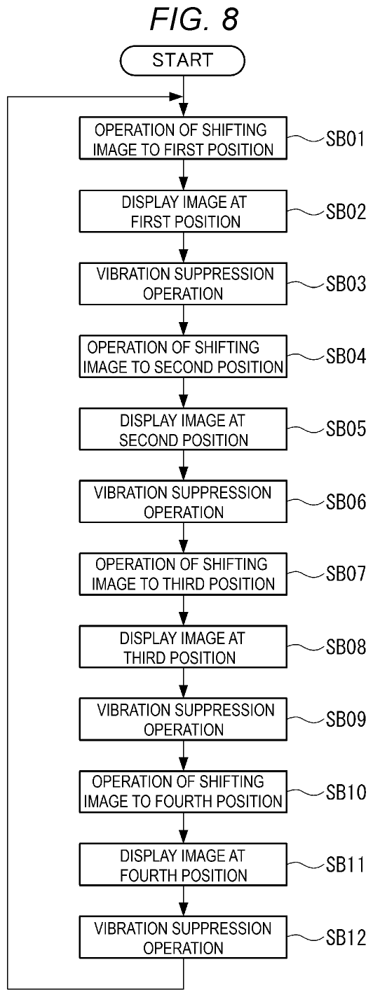

FIG. 8 describes second synchronization control performed by the control apparatus 7 to synchronize the optical path shifter 4 and the vibration suppressor 5 with each other.

For example, after the shift operation controller 72 causes the optical path shifter 4 to perform the optical path shift operation, the control apparatus 7 may perform the second synchronization control in which the vibration suppression operation controller 74 causes the vibration suppressor 5 to perform the vibration suppression operation of changing the optical path of the image light based on the vibration suppression waveform, as shown in FIG. 8. That is, in the second synchronization control, the vibration suppression operation is performed in synchronization with a timing between adjacent optical path shift operations, and the optical path shift operation and the vibration suppression operation are alternately performed.

Specifically, in the second synchronization control, the shift operation controller 72 performs the optical path shift operation of displaying the projection image at the first position P1 (step SB01). The projection image is thus displayed at the first position P1 (step SB02).

After step SB01, the vibration suppression operation controller 74 performs the vibration suppression operation (step SB03). Therefore, in the second synchronization control, the vibration suppressor 5 changes the optical path of the image light with the projection image displayed at the first position in such a way that the vibration is reduced.

After step SB03, the shift operation controller 72 performs the optical path shift operation of displaying the projection image at the second position P2 (step SB04). The projection image is thus displayed at the second position P2 (step SB05). After step SB04, the vibration suppression operation controller 74 performs the vibration suppression operation (step SB06).

After step SB06, the shift operation controller 72 performs the optical path shift operation of displaying the projection image at the third position P3 (step SB07). The projection image is thus displayed at the third position P3 (step SB08). After step SB07, the vibration suppression operation controller 74 performs the vibration suppression operation (step SB09).

After step SB09, the shift operation controller 72 performs the optical path shift operation of displaying the projection image at the fourth position P4 (step SB10). The projection image is thus displayed at the fourth position P4 (step SB11). After step SB10, the vibration suppression operation controller 74 performs the vibration suppression operation (step SB12).

The control apparatus 7 then return to step SB01, and performs the vibration suppression operation in synchronization with the timing between the optical path shift operations. Since the refresh rate at which the light modulators 351 each generate an image to be displayed at each position on the projection receiving surface PS is 240 Hz, steps SB01, SB02, and SB03, steps SB04, SB05, and SB06, steps SB07, SB08, and SB09, and steps SB10, SB11, and SB12 are successively executed at 240 Hz.

### Effects of First Embodiment

The projector 1 according to the present embodiment described above provides the effects below.

The projector 1 includes the illuminator 31, the image formation apparatus 33, the projection optical apparatus 37, the optical path shifter 4, the vibration suppressor 5, and the vibration detection sensor 6.

The illuminator 31 outputs the illumination light. The image formation apparatus 33 forms image light based on the incident illumination light. The projection optical apparatus 37 projects the image light formed by the image formation apparatus 33.

The optical path shifter 4 is disposed in the optical path of the image light between the image formation apparatus 33 and the projection optical apparatus 37. The optical path shifter 4 shifts the optical path of the image light with respect to the reference position where the image light is projected onto the projection receiving surface PS. The reference position is the first position P1.

The vibration detection sensor 6 detects vibration that affects the position where the projection optical apparatus 37 projects the image light.

The vibration suppressor 5 is disposed at either the image light incident side or the image light exiting side of the optical path shifter 4 in the optical path of the image light between the image formation apparatus 33 and the projection optical apparatus 37. The vibration suppressor 5 includes the optical member 51, through which the image light passes. The vibration suppressor 5 then swings the optical member 51 based on the result of detection performed by the vibration detection sensor 6 to change the optical path of the image light having entered the optical member 51 in the direction in which the reverse phase of the phase of the vibration is produced.

According to the configuration described above, even when vibration that affects the position where the projection optical apparatus 37 projects the image light acts on the projector 1, the vibration suppressor 5 can swing the optical member 51 based on the result of detection performed by the vibration detection sensor 6 to suppress the vibration of the projection image on the projection receiving surface PS. The fact that the thus configured vibration suppressor 5 is provided separately from the optical path shifter 4 simultaneously allows suppression of image vibration performed by the vibration suppressor 5 and pseudo-improvement in the image resolution performed by the optical path shifter 4. Therefore, even when the vibration occurs, the resolution of the projection image can be improved in a pseudo manner.

In the projector 1, the vibration suppressor 5 is disposed at the side of the optical path shifter 4 on which the image light PL is incident. The vibration suppressor 5 changes the optical path of the image light PL that enters the optical member 51 from the image formation apparatus 33. On the other hand, the optical path shifter 4 shifts the optical path of the incident image light PL that travels along the optical path changed by the optical member 51.

According to the configuration described above, the optical path of the image light PL that enters the optical path shifter 4 is changed by the vibration suppressor 5 to the optical path along which the image light PL is projected onto the reference position. The optical path shifter 4 that operates as described above can therefore shift the optical path of the incident image light PL with respect to the reference position. The resolution of the projection image can therefore be improved in a pseudo manner with the vibration suppressed.

As described above, the vibration suppressor 5 may be disposed at the side of the optical path shifter 4 via which the image light PL exits.

In this case, the optical path shifter 4 shifts the optical path of the image light incident from the image formation apparatus 33, and the vibration suppressor 5 changes the optical path of the incident image light PL that travels along the optical path shifted by the optical path shifter 4.

In this case, the optical path of the image light PL that enters the vibration suppressor 5 is the optical path shifted by the optical path shifter 4 with respect to the reference position. The vibration suppressor 5 that operates as described above can therefore suppress the vibration of the projection image while improving the resolution of the projection image in a pseudo manner.

In the projector 1, the vibration suppressor 5 includes the first driver 55, which swings the optical member 51 around the first swing axis Rx1, which intersects with the Y-axis. The Y-axis is the axis extending along the vertical direction when the projector 1 is provided. That is, the first swing axis Rx1 intersects with the imaginary plane containing the vertical direction and the optical axis direction in which the image light passes. In other words, the first swing axis Rx1 intersects with the YZ-plane defined by the vertical direction and the optical axis along which the image formation apparatus 33 outputs the image light. In the present embodiment, the second swing axis Rx2 also intersects with the imaginary plane containing the vertical direction and the optical axis direction in which the image light passes.

When the projection image vibrates in the vertical direction, a viewer is likely to recognize the vibration.

In contrast, when the first swing axis Rx1 of the optical member 51 intersects with the imaginary plane containing the vertical direction and the optical axis direction along which the image light passes, the vibration suppressor 5 can move the optical path of the image light to be projected in the vertical direction. The vibration suppressor 5 can therefore shift the optical path of the image light in the opposite direction of the direction of the vibration along the vertical direction, causing the viewer to unlikely to recognize the vibration along the vertical direction, which is likely to be recognized by the viewer. The same holds true for the second swing axis Rx2.

In the projector 1, the vibration suppressor 5 includes the second driver 56, which swings the optical member 51 around the second swing axis Rx2, which is perpendicular to the first swing axis Rx1. The first swing axis Rx1 and the second swing axis Rx2 each intersect with the direction of the vibration.

According to the configuration described above, the optical member 51 can be swung not only around the first swing axis Rx1 but also around the second swing axis Rx2, so that the number of directions of the vibration to be suppressed by the vibration suppressor 5 can be increased. The vibration can therefore be efficiently suppressed.

The projector 1 includes, the image formation apparatus 33, the projection optical apparatus 37, the optical path shifter 4, the vibration suppressor 5, the vibration detection sensor 6, and the control apparatus 7.

The image formation apparatus 33 forms image light from incident illumination light, and the projection optical apparatus 37 projects the image light formed by the image formation apparatus.

The optical path shifter 4 is disposed in the optical path of the image light between the image formation apparatus 33 and the projection optical apparatus 37. The optical path shifter 4 shifts the optical path of the image light with respect to the reference position where the image light is projected. The vibration detection sensor 6 detects vibration that affects the position where the projection optical apparatus projects the image light. The vibration suppressor 5 is disposed at either the image light incident side or the image light exiting side of the optical path shifter 4 in the optical path of the image light between the image formation apparatus 33 and the projection optical apparatus 37. The vibration suppressor 5 includes an optical member through which the image light passes.

The control apparatus 7 controls the vibration suppressor 5. The control apparatus 7 includes the vibration suppression waveform generator 73, which acquires the result of detection performed by the vibration detection sensor 6 and generates the vibration suppression waveform having the reverse phase of the phase of the vibration based on the result of detection performed by the vibration detection sensor 6, and the vibration suppression operation controller 74, which drives the vibration suppressor 5 based on the generated vibration suppression waveform.

According to the configuration described above, the control apparatus 7, which drives the vibration suppressor 5 in accordance with the vibration suppression waveform based on the result of detection performed by the vibration detection sensor 6, allows both the vibration suppressor 5 to suppress the image vibration and the optical path shifter 4 to improve the image resolution in a pseudo manner, as described above. Therefore, even when the vibration occurs, the resolution of the image to be projected can be improved in a pseudo manner.

In the first synchronization control, the control apparatus 7 drives the vibration suppressor 5 based on the vibration suppression waveform in synchronization with the timing of the operation of shifting the optical path of the image light performed by the optical path shifter 4.

According to the configuration described above, the vibration suppressor 5 changes the optical path of the image light at the timing at which the optical path shifter 4 shifts the optical path of the image light. That is, the timing at which the vibration suppressor 5 operates and the timing at which the optical path shifter 4 operates substantially coincide with each other.

Even in this case, the effect of the vibration on the image light can be reduced, and the resolution of the image to be projected can be improved in a pseudo manner.

In the second synchronization control, the control apparatus 7 drives the vibration suppressor 5 based on the vibration suppression waveform in synchronization with the timing between the image light optical path shift operations performed by the optical path shifter 4. That is, in the second synchronization control, the vibration suppression operation is performed between the current optical path shift operation and the following optical path shift operation.

According to the configuration described above, the vibration suppressor 5 changes the optical path of the image light between the timing at which the optical path shifter 4 shifts the optical path of the image light and the timing at which the optical path shifter 4 shifts the optical path of the image light next time. That is, the vibration suppressor 5 operates after the optical path shifter 4 shifts the optical path of the image light.

Even in this case, the effect of the vibration on the image light can be reduced, and the resolution of the image to be projected can be improved in a pseudo manner. That is, the optical path of the image light is shifted by the vibration suppressor 5 in the opposite direction of the direction of the vibration at the timing when the projection image is displayed at the projection receiving surface PS, so that the effect of the vibration on the projection image can be further reduced, and the viewer's visual recognition of the swing motion of the image caused by the vibration can be suppressed.

### Variation of First Embodiment

The vibration suppressor 5 described above swings the optical member 51, through which the image light passes, around the first swing axis Rx1 and the second swing axis Rx2 to refract the image light PL passing through the optical member 51, thereby changing the optical path of the image light PL. In other words, the vibration suppressor 5 includes the first driver 55, which swings the optical member 51 around the first swing axis Rx1, and the second driver 56, which swings the optical member 51 around the second swing axis Rx2, but not necessarily.

The vibration suppressor 5 may swing the optical member 51 around one swing axis. That is, the projection image movement direction in which the projection image moves in the direction in which the vibration is canceled out may be the direction along one axis. In other words, the vibration suppressor 5 may include only one of the first driver 55 and the second driver 56.

In this case, it is preferable that the swing axis of the optical member 51 intersects with the Y-axis. In detail, it is preferable that the swing axis of the optical member 51 is perpendicular to the Y-axis. That is, it is preferable that the swing axis of the optical member 51 is perpendicular to the vertical direction in the state in which the projector 1 is installed.

Also in this case, since the vibration suppressor 5 can move the optical path of the image light to be projected in the vertical direction, the optical path of the image light can be shifted in the direction in which the vibration along the vertical direction is canceled out, so that the vibration of the projection image along the vertical direction, in which the viewer is likely to visually recognize vibration, can be suppressed, as in the projector 1 described above.

Note that the state in which an axis is perpendicular to the Y-axis includes the state in which the axis is substantially perpendicular to the Y-axis, and that an axis is parallel to the X-axis includes the state in which the axis is substantially parallel to the X-axis.

### Second Embodiment

A second embodiment of the present disclosure will next be described.

The projector according to the present embodiment has a configuration that is the same as that of the projector 1 according to the first embodiment but differs therefrom in that the optical path shifter 4 is configured to improve the resolution of the projection image in a pseudo manner and reduce the swing motion of the projection image. In the following description, portions that are the same or substantially the same as the portions having been already described have reference characters that are the same as those in the previous description and will not be described.

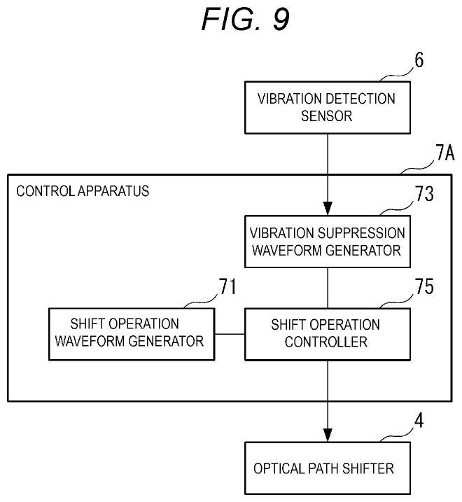

FIG. 9 is a block diagram showing the configuration of a control apparatus 7A provided in the projector according to the present embodiment.

The projector according to the present embodiment has a configuration and functions that are the same as those of the projector 1 according to the first embodiment except that the vibration suppressor 5 and the control apparatus 7 are replaced with the control apparatus 7A shown in FIG. 9. In the projector according to the present embodiment, the optical path shifter 4 is configured to improve the resolution of the projection image in a pseudo manner and function as the vibration suppressor to reduce the swing motion of the projection image under the control of the control apparatus 7A.

The control apparatus 7A has a configuration and functions that are the same as those of the control apparatus 7 according to the first embodiment except that the shift operation controller 72 and the vibration suppression operation controller 74 are replaced with a shift operation controller 75. That is, the control apparatus 7A includes the shift operation waveform generator 71, the vibration suppression waveform generator 73, and the shift operation controller 75.

The shift operation controller 75 performs control that is the same as the second synchronization control shown in FIG. 8 to operate the optical path shifter 4 based on the shift operation waveform generated by the shift operation waveform generator 71 and the vibration suppression waveform generated by the vibration suppression waveform generator 73 based on the result of detection performed by the vibration detection sensor 6.

Specifically, in step SB01, the shift operation controller 75 causes the optical path shifter 4 to perform the optical path shift operation of displaying the projection image at the first position based on the shift operation waveform. The projection image is thus displayed at the first position P1 in step SB02. After step SB01, the shift operation controller 75 performs the vibration suppression operation based on the vibration suppression waveform in step SB03. That is, in step SB03, the shift operation controller 75 performs the vibration suppression operation of changing the optical path of the image light PL that enters the optical path changing member 41 in the direction in which the reverse phase of the phase of the detected vibration is produced. The optical path of the image light PL is thus changed in the opposite direction of the direction in which the projection image is moved by the vibration at the projection receiving surface PS, so that the vibration of the projection image at the projection receiving surface PS is suppressed.

In step SB04, which is executed after step SB03, the shift operation controller 75 performs the optical path shift operation of displaying the projection image at the second position P2 based on the shift operation waveform. The projection image is thus displayed at the second position P2 in step SB05. After step SB04, the shift operation controller 75 performs the vibration suppression operation based on the vibration suppression waveform in step SB06. The optical path of the image light PL is thus changed in the opposite direction of the direction in which the projection image is moved by the vibration at the projection receiving surface PS, so that the vibration of the projection image at the projection receiving surface PS is suppressed.

The same holds true for steps SB07, SB08, and SB09 and steps SB10, SB11, and SB12. When steps SB07, SB08, and SB09 are executed, the projection image is displayed at the third position P3, and the swing motion of the projection image at the projection receiving surface PS is suppressed. When steps SB10, SB11, and SB12 are executed, the projection image is displayed at the fourth position P4, and the swing motion of the projection image at the projection receiving surface PS is suppressed.

### Effects of Second Embodiment

The projector according to the present embodiment described above provides the effects below as well as effects that are the same as those provided by the projector 1 according to the first embodiment.

The projector according to the present embodiment includes the illuminator 31, the image formation apparatus 33, the projection optical apparatus 37, the optical path shifter 4, and the vibration detection sensor 6.

The illuminator 31 outputs the illumination light. The image formation apparatus 33 forms the image light PL based on the incident illumination light. The projection optical apparatus 37 projects the image light PL formed by the image formation apparatus 33.

The vibration detection sensor 6 detects vibration that affects the position where the projection optical apparatus 37 projects the image light PL.

The optical path shifter 4 includes the optical path changing member 41, which is disposed in the optical path of the image light PL between the image formation apparatus 33 and the projection optical apparatus 37. The optical path shifter 4 swings the optical path changing member 41 around the axes Ax1 and Ax2, which intersect with the direction in which the image light PL is incident to shift the optical path of the image light PL with respect to the first position P1, where the image light is projected. The first axis Ax1 and the second axis Ax2 each correspond to the swing axis, and the first position P1 corresponds to the reference position.

The optical path shifter 4 alternately performs the pixel shift operation of shifting the optical path of the image light PL with respect to the first position P1, and the vibration suppression operation of changing the optical path of the image light PL that enters the optical path changing member 41 in the direction in which the reverse phase of the phase of the vibration is produced by swinging the optical path changing member 41 based on the result of detection performed by the vibration detection sensor 6.

The configuration described above, in which the optical path shifter 4 alternately performs the pixel shift operation and the vibration suppression operation, can improve the resolution of the projection image in a pseudo manner and at the same time suppress the swing motion of the projection image due to the vibration. Therefore, even when the vibration occurs, the resolution of the projection image can be improved in a pseudo manner.

The projector according to the present embodiment includes the image formation apparatus 33, the projection optical apparatus 37, the optical path shifter 4, the vibration detection sensor 6, and the control apparatus 7A.

The image formation apparatus 33 forms the image light PL from the incident illumination light, and the projection optical apparatus 37 projects the image light PL.

The optical path shifter 4 is disposed in the optical path of the image light PL between the image formation apparatus 33 and the projection optical apparatus 37. The optical path shifter 4 shifts the optical path of the image light PL with respect to the first position P1, where the image light PL is projected onto the projection receiving surface PS. The first position P1 corresponds to the reference position. The vibration detection sensor 6 detects vibration that affects the position where the projection optical apparatus 37 projects the image light PL.

The control apparatus 7A controls the optical path shifter 4.

The control apparatus 7A causes the optical path shifter 4 to alternately perform the pixel shift operation of shifting the optical path of the image light PL with respect to the first position P1, and the vibration suppression operation of generating a vibration suppression waveform that produces the reverse phase of the phase of the detected vibration based on the result of detection performed by the vibration detection sensor 6 and suppressing the vibration based on the generated vibration suppression waveform.

According to the configuration described above, in which the control apparatus 7A causes the optical path shifter 4 to alternately perform the pixel shift operation and the vibration suppression operation, can improve the resolution of the projection image in a pseudo manner and at the same time suppress the swing motion of the projection image due to the vibration, as described above. Therefore, even when the vibration occurs, the resolution of the projection image can be improved in a pseudo manner.

### Variations of Embodiments

The present disclosure is not limited to the embodiments described above, and variations, improvements, and other modifications to the extent that the advantage of the present disclosure is achieved fall within the scope of the present disclosure.

In the embodiments described above, the optical path shifter 4 swings the optical path changing member 41, through which the image light passes, around the first axis Ax1 and the second axis Ax2 to refract the image light PL passing through the optical path changing member 41, thereby shifting the optical path of the image light PL. In other words, the optical path shifter 4 includes the first driver 45, which swings the optical path changing member 41 around the first axis Ax1, and the second driver 46, which swings the optical path changing member 41 around the second axis Ax2. One of the first axis Ax1 and the second axis Ax2 corresponds to the first swing axis, and the other axis corresponds to the second swing axis, but not necessarily.

The optical path shifter 4 may swing the optical path changing member 41 around one axis. In other words, the optical path shifter 4 may include only one of the first driver 45 and the second driver 46.

It is preferable that the swing axis of the optical path changing member 41 intersects with the Y-axis. That is, it is preferable that the swing axis of the optical path changing member 41 intersects with the vertical direction in the state in which the projector 1 is provided. Also in this case, the optical path shifter 4 can improve the resolution of the projection image in a pseudo manner.

In the second embodiment, since the swing axis of the optical path shifter 4 intersects with the Y-axis, the optical path of the image light to be projected can be shifted in the vertical direction and in the opposite direction of the vertical direction, so that vibration of the projection image that occurs along the vertical direction, in which the viewer is likely to recognize vibration, can be suppressed.

In the first embodiment described above, the vibration suppressor 5 includes the first driver 55 including the first actuator 551 and the second actuator 555, and the second driver 56 including the first actuator 561 and the second actuator 565. In each of the embodiments described above, the optical path shifter 4 includes the first driver 45 including the first actuator 451 and the second actuator 455, and the second driver 46 including the first actuator 461 and the second actuator 465, but not necessarily. The first driver 45 provided in the optical path shifter 4 may include only one of the first actuator 451 and the second actuator 455, and the second driver 46 provided in the optical path shifter 4 may include only one of the first actuator 461 and the second actuator 465. The first driver 55 provided in the vibration suppressor 5 may include only one of the first actuator 551 and the second actuator 555, and the second driver 56 provided in the vibration suppressor 5 may include only one of the first actuator 561 and the second actuator 565.

In the first embodiment described above, the optical path shifter 4 and the vibration suppressor 5 differ from each other in the orientation of each of the swing axes of the optical path changing member 41 and the optical member 51, as well as in the arrangement of the drivers, but not necessarily. The optical path shifter 4 and the vibration suppressor 5 may have the same configuration and structure. In this case, when the optical path shifter 4 and the vibration suppressor 5 are configured to differ from each other in the orientation of each of the swing axes, the optical path shifter 4 and the vibration suppressor 5 may be disposed with one of the optical path shifter 4 and the vibration suppressor 5 rotated by a predetermined angle around the Z-axis.

In the second embodiment described above, the optical path shifter 4 is configured to improve the resolution of the projection image in a pseudo manner and suppress the swing motion of the projection image at the projection receiving surface PS, but not necessarily. The vibration suppressor 5 may instead be configured to improve the resolution of the projection image in a pseudo manner and suppress the swing motion of the projection image at the projection receiving surface PS. That is, the configuration of the optical path shifter and the configuration of the vibration suppressor employed in the projector according to the present disclosure are not limited to those described above.

In each of the embodiments described above, the projector includes the three light modulation modules 35R, 35G, and 35B, but not necessarily. The projector may include two or less or four or more light modulation modules.

In each of the embodiments described above, the image projection unit 3 includes the optical parts arranged in the layout shown in FIG. 1, but not necessarily. The layout and configuration of the image projection unit employed in the projector according to the present disclosure are not limited to those described above and can be changed as appropriate.

In the embodiments described above, the optical axis from the light combiner 36 to the light exiting end of the projection optical apparatus 37 extends linearly, and the projection optical apparatus 37 outputs the image light toward the positive end of the Z-direction, but not necessarily. The direction in which the projection optical apparatus outputs the image light may be the Z-direction toward the negative end thereof, which is the opposite direction of the Z-direction toward the positive end thereof, with the aid, for example, of a reflection mirror. The optical axis of the projection optical apparatus may be deflected by an optical path changing mirror into an optical axis having an L-letter shape, so that the direction in which the projection optical apparatus outputs the image light is the X-direction toward the positive or negative end thereof. In this case, the optical path shifter 4 and the vibration suppressor 5 are each disposed in the optical path between the light combiner 36 and the optical path changing mirror.

The present disclosure is also applicable to a method for forming image light by using one light modulator. In this method, in which no light combiner is used, the optical path shifter 4 and the vibration suppressor 5 are disposed between the light modulator and the projection optical apparatus.

Note that the present disclosure is also applicable to a projector including height-adjustable legs and capable of changing the direction in which the projection optical apparatus outputs light by using the leg height adjustment function. The present disclosure is further applicable not only to a projector provided at an installation surface such as a stand, but also to a projector provided at an installation surface such as a ceiling or a wall by using an attachment apparatus.

In each of the embodiments described above, the light modulators 351 are each formed of a transmissive liquid crystal panel having a light incident surface and a light exiting surface different from each other, but not necessarily. The light modulators may each be formed of a reflective liquid crystal panel having a surface that serves both as the light incident surface and the light exiting surface. Furthermore, a light modulator using any component other than a liquid-crystal-based component and capable of modulating an incident luminous flux to form an image according to image information, such as a device using micromirrors, for example, a digital micromirror device (DMD), may be employed. In this case, the light-incident-side polarizers 352 and the light-exiting-side polarizers 353 can be omitted.

### Summary of Present Disclosure

The present disclosure will be summarized below as additional remarks.

### Additional Remark 1

A projector including an illuminator that outputs illumination light, an image formation apparatus that forms image light from the illumination light that enters the image formation apparatus, a projection optical apparatus that projects the image light formed by the image formation apparatus, an optical path shifter that is disposed in the optical path of the image light between the image formation apparatus and the projection optical apparatus and shifts the optical path of the image light with respect to a reference position where the image light is projected, a vibration detection sensor that detects vibration that affects the position where the projection optical apparatus projects the image light, and a vibration suppressor that is disposed at either the side of the optical path shifter on which the image light is incident or via which the image light exits in the optical path of the image light between the image formation apparatus and the projection optical apparatus and includes an optical member through which the image light passes, the vibration suppressor swinging the optical member based on the result of detection performed by the vibration detection sensor to change the optical path of the image light having entered the optical member in the direction in which the reverse phase of the phase of the vibration is produced.

According to the configuration described above, even when vibration that affects the position where the projection optical apparatus projects the image light acts on the projector, the vibration suppressor can swing the optical member based on the result of detection performed by the vibration detection sensor to suppress the vibration of an image according to the projected image light at a projection receiving surface. Since the thus configured vibration suppressor is provided separately from the optical path shifter, the vibration suppressor can suppress the image vibration, and at the same time the optical path shifter can improve the resolution of the image in a pseudo manner. Therefore, even when the vibration occurs, the resolution of the image to be projected can be improved in a pseudo manner.

### Additional Remark 2

The projector described in the additional remark 1, in which the vibration suppressor is disposed at the side of the optical path shifter on which the image light is incident, and changes the optical path of the image light that enters the optical member from the image formation apparatus, and the optical path shifter shifts the optical path of the image light that travels along the optical path changed by the optical member and enters the optical path shifter.

According to the configuration described above, the optical path of the image light that enters the optical path shifter is changed by the vibration suppressor to the optical path along which the image light is projected onto the reference position. The optical path shifter that operates as described above can therefore shift the optical path of the incident image light with respect to the reference position, so that the resolution of the image to be projected can be improved in a pseudo manner with the vibration suppressed.

### Additional Remark 3

The projector described in the additional remark 1, in which the vibration suppressor is disposed at the side of the optical path shifter via which the image light exits, the optical path shifter shifts the optical path of the image light incident from the image formation apparatus, and the vibration suppressor changes the optical path of the image light that travels along the optical path shifted by the optical path shifter and enters the vibration suppressor.

According to the configuration described above, the optical path of the image light that enters the vibration suppressor is the optical path shifted by the optical path shifter with respect to the reference position. The vibration suppressor that operates as described above can therefore suppress the vibration of the image to be projected while improving the resolution of the image to be projected in a pseudo manner.

### Additional Remark 4

The projector described in any one of the additional remarks 1 to 3, in which the vibration suppressor includes a first driver that swings the optical member around a first swing axis that intersects with an imaginary plane containing the vertical direction and the optical axis direction in which the image light passes.

When the projected image vibrates in the vertical direction, the viewer of the image is likely to recognize the vibration.

In contrast, the first swing axis of the optical member intersects with the imaginary plane containing the vertical direction and the optical axis direction along which the image light passes, so that the vibration suppressor can move the optical path of the image light to be projected in the vertical direction. The vibration suppressor can therefore shift the optical path of the image light in the opposite direction of the direction of the vibration along the vertical direction, causing the viewer to unlikely to recognize the vibration along the vertical direction, in which the viewer is likely to visually recognize vibration.

### Additional Remark 5

The projector described in the additional remark 4, in which the vibration suppressor includes a second driver that swings the optical member around a second swing axis perpendicular to the first swing axis, and the first swing axis and the second swing axis each intersect with the direction of the vibration.

According to the configuration described above, the optical member can be swung not only around the first swing axis but also around the second swing axis, so that the number of directions of the vibration to be suppressed by the vibration suppressor can be increased. The vibration can therefore be efficiently suppressed.

### Additional Remark 6

A control apparatus of a vibration suppressor of a projector including an optical path shifter that is disposed in the optical path of image light between an image formation apparatus that forms the image light from illumination light incident thereon and a projection optical apparatus that projects the image light, the optical path shifter shifting the optical path of the image light with respect to a reference position where the image light is projected, a vibration detection sensor that detects vibration that affects the position where the projection optical apparatus projects the image light, and the vibration suppressor, which is disposed at either the side of the optical path shifter on which the image light is incident or via which the image light exits in the optical path of the image light between the image formation apparatus and the projection optical apparatus, the vibration suppressor including an optical member through which the image light passes, the control apparatus acquiring the result of detection performed by the vibration detection sensor, generating a vibration suppression waveform that produces the reverse phase of the phase of the vibration based on the result of the detection, and driving the vibration suppressor based on the vibration suppression waveform.

According to the configuration described above, the control apparatus drives the vibration suppressor in accordance with the vibration suppression waveform based on the result of detection performed by the vibration detection sensor to cause the vibration suppressor to suppress the image vibration and at the same time the optical path shifter to improve the image resolution in a pseudo manner, as in the projector according to the additional remark 1 described above. Therefore, even when the vibration occurs, the resolution of the image to be projected can be improved in a pseudo manner.

### Additional Remark 7

The control apparatus described in the additional remark 6, which drives the vibration suppressor based on the vibration suppression waveform in synchronization with the timing at which the optical path shifter shifts the optical path of the image light.

According to the configuration described above, the vibration suppressor changes the optical path of the image light at the timing at which the optical path shifter shifts the optical path of the image light. That is, the timing at which the vibration suppressor operates and the timing at which the optical path shifter operates substantially coincide with each other.

Even in this case, the effect of the vibration on the image light can be reduced, and the resolution of the image to be projected can be improved in a pseudo manner.

### Additional Remark 8

The control apparatus described in the additional remark 6, which drives the vibration suppressor based on the vibration suppression waveform in synchronization with the timing between the operations of shifting the optical path of the image light performed by the optical path shifter.

According to the configuration described above, the vibration suppressor changes the optical path of the image light between the timing at which the optical path shifter shifts the optical path of the image light and the timing at which the optical path shifter shifts the optical path of the image light next time. That is, the vibration suppressor operates after the optical path shifter shifts the optical path of the image light.

Even in this case, the effect of the vibration on the image light can be reduced, and the resolution of the image to be projected can be improved in a pseudo manner. That is, the optical path of the image light is shifted by the vibration suppressor in the opposite direction of the direction of the vibration at the timing when an image according to the projected image light is displayed on the projection receiving surface, so that the effect of the vibration on the projected image can be further reduced, and the viewer's visual recognition of the swing motion of the image caused by the vibration can be suppressed.

### Additional Remark 9

A projector including an illuminator that outputs illumination light, an image formation apparatus that forms image light from the illumination light incident thereon, a projection optical apparatus that projects the image light formed by the image formation apparatus, an optical path shifter that includes an optical path changing member disposed in the optical path of the image light between the image formation apparatus and the projection optical apparatus and swings the optical path changing member around a swing axis that intersects with the direction in which the image light is incident to shift the optical path of the image light with respect to a reference position where the image light is projected, and a vibration detection sensor that detects vibration that affects the position where the projection optical apparatus projects the image light, the optical path shifter alternately performing pixel shift operation of shifting the optical path of the image light with respect to the reference position, and vibration suppression operation of changing the optical path of the image light that enters the optical path changing member in a direction in which the reverse phase of the phase of the vibration is produced by swinging the optical path changing member based on the result of detection performed by the vibration detection sensor.

The configuration described above, in which the optical path shifter alternately performs the pixel shift operation and the vibration suppression operation, can improve the resolution of the image to be projected in a pseudo manner and at the same time suppress the swing motion of the projected image due to the vibration. Therefore, even when the vibration occurs, the resolution of the projected image can be improved in a pseudo manner.

### Additional Remark 10

A control apparatus of a projector including the optical path shifter that is disposed in the optical path of image light between an image formation apparatus that forms the image light from illumination light incident thereon and a projection optical apparatus that projects the image light, the optical path shifter controlled by the control apparatus to shift the optical path of the image light with respect to a reference position where the image light is projected, a vibration detection sensor that detects vibration that affects the position where the projection optical apparatus projects the image light, the control apparatus causing the optical path shifter to alternately perform pixel shift operation of shifting the optical path of the image light with respect to a reference position, and vibration suppression operation of generating a vibration suppression waveform that produces the reverse phase of the phase of the vibration based on the result of detection performed by the vibration detection sensor and suppressing the vibration based on the generated vibration suppression waveform.

According to the configuration described above, the control apparatus, which causes the optical path shifter to alternately perform the pixel shift operation and the vibration suppression operation, can improve the resolution of the image to be projected in a pseudo manner and at the same time suppress the swing motion of the projected image due to the vibration, as the control apparatus according to the additional remark 9 described above can. Therefore, even when the vibration occurs, the resolution of the projected image can be improved in a pseudo manner.

What is claimed is:

1. A projector comprising:
an illuminator that outputs illumination light;
an image formation apparatus that forms image light from the illumination light that enters the image formation apparatus;
a projection optical apparatus that projects the image light formed by the image formation apparatus;
an optical path shifter that is disposed in an optical path of the image light between the image formation apparatus and the projection optical apparatus and shifts the optical path of the image light with respect to a reference position where the image light is projected;
a vibration detection sensor that detects vibration that affects the position where the projection optical apparatus projects the image light; and
a vibration suppressor that is disposed at either a side of the optical path shifter on which the image light is incident or via which the image light exits in the optical path of the image light between the image formation apparatus and the projection optical apparatus and includes an optical member through which the image light passes,
wherein the vibration suppressor swings the optical member based on a result of detection performed by the vibration detection sensor to change the optical path of the image light that enters the optical member in a direction in which a reverse phase of a phase of the vibration is produced.

2. The projector according to claim 1,
wherein the vibration suppressor is disposed at the side of the optical path shifter on which the image light is incident, and changes the optical path of the image light that enters the optical member from the image formation apparatus, and
the optical path shifter shifts the optical path of the image light that travels along the optical path changed by the optical member and enters the optical path shifter.

3. The projector according to claim 1,
wherein the vibration suppressor is disposed at the side of the optical path shifter via which the image light exits,
the optical path shifter shifts the optical path of the image light incident from the image formation apparatus, and
the vibration suppressor changes the optical path of the image light that travels along the optical path shifted by the optical path shifter and enters the vibration suppressor.

4. The projector according to claim 1,
wherein the vibration suppressor includes a first driver that swings the optical member around a first swing axis that intersects with an imaginary plane containing a vertical direction and an optical axis direction in which the image light passes.

5. The projector according to claim 4,
wherein the vibration suppressor includes a second driver that swings the optical member around a second swing axis perpendicular to the first swing axis, and
the first swing axis and the second swing axis each intersect with a direction of the vibration.

6. The projector according to claim 1,
wherein the optical path shifter has first and second swing axes around which the optical path shifter swings in directions perpendicular to each other,
the vibration suppressor has first and second swing axes around which the optical member swings in directions perpendicular to each other, and
the first and second swing axes of the vibration suppressor do not coincide with the first and second swing axes of the optical path shifter.

7. The projector according to claim 6,
wherein the first and second swing axes of the vibration suppressor incline by 45° with respect to the first and second swing axes of the optical path shifter, respectively.

8. A control apparatus of a projector including an optical path shifter that is disposed in an optical path of image light between an image formation apparatus that forms the image light from illumination light that enters the image formation apparatus and a projection optical apparatus that projects the image light, the optical path shifter shifting the optical path of the image light with respect to a reference position where the image light is projected, a vibration detection sensor that detects vibration that affects the position where the projection optical apparatus projects the image light, and a vibration suppressor that is disposed at either a side of the optical path shifter on which the image light is incident or via which the image light exits in the optical path of the image light between the image formation apparatus and the projection optical apparatus, the vibration suppressor including an optical member through which the image light passes and controlled by the control apparatus,
wherein the control apparatus
acquires a result of detection performed by the vibration detection sensor,
generates a vibration suppression waveform that produces a reverse phase of a phase of the vibration based on the result of the detection, and
drives the vibration suppressor based on the vibration suppression waveform.

9. The control apparatus according to claim 8,
wherein the control apparatus drives the vibration suppressor based on the vibration suppression waveform in synchronization with a timing at which the optical path shifter shifts the optical path of the image light.

10. The control apparatus according to claim 8,
wherein the control apparatus drives the vibration suppressor based on the vibration suppression waveform in synchronization with a timing between the operations of shifting the optical path of the image light performed by the optical path shifter.

11. A projector comprising:
an illuminator that outputs illumination light;
an image formation apparatus that forms image light from the illumination light that enters the image formation apparatus;
a projection optical apparatus that projects the image light formed by the image formation apparatus;
an optical path shifter that includes an optical path changing member disposed in an optical path of the image light between the image formation apparatus and the projection optical apparatus and swings the optical path changing member around a swing axis that intersects with a direction in which the image light is incident to shift the optical path of the image light with respect to a reference position where the image light is projected; and
a vibration detection sensor that detects vibration that affects the position where the projection optical apparatus projects the image light,
wherein the optical path shifter alternately performs pixel shift operation of shifting the optical path of the image light with respect to the reference position, and vibration suppression operation of changing the optical path of the image light that enters the optical path changing member in a direction in which a reverse phase of a phase of the vibration is produced by swinging the optical path changing member based on a result of detection performed by the vibration detection sensor.

12. A control apparatus of a projector including an optical path shifter that is disposed in an optical path of image light between an image formation apparatus that forms the image light from illumination light that enters the image formation apparatus and a projection optical apparatus that projects the image light, the optical path shifter controlled by the control apparatus to shift the optical path of the image light with respect to a reference position where the image light is projected, and a vibration detection sensor that detects vibration that affects the position where the projection optical apparatus projects the image light,
wherein the control apparatus causes the optical path shifter to alternately perform pixel shift operation of shifting the optical path of the image light with respect to a reference position, and vibration suppression operation of generating a vibration suppression waveform that produces a reverse phase of a phase of the vibration based on a result of detection performed by the vibration detection sensor and suppressing the vibration based on the generated vibration suppression waveform.
